(19) United States
(12) Patent Application Publication
(10) Pub. No.: US 2011/0210895 A1
(43) Pub. Date: Sep. 1, 2011

(54) MOTOR VEHICLE ANTENNA SYSTEM

(76) Inventors: Peter Marcus Buff, III, Garner, NC (US); Michael Bernard Steer, Raleigh, NC (US); Jay H. McCandless, Durham, NC (US); Russell Evans Winstead, Raleigh, NC (US)

(21) Appl. No.: 13/127,543

(22) PCT Filed: Sep. 4, 2009
(86) PCT No.: PCT/US09/56065

§ 371 Date: May 4, 2011

Related U.S. Application Data
(60) Provisional application No. 61/111,191, filed on Nov. 4, 2008.

(51) Int. Cl. H01Q 1/32

(52) U.S. Cl. 343/712; 343/711

(57) ABSTRACT

A covert antenna or radio frequency probe assembly for a motor vehicle includes a substantially planar antenna or probe element including a sheet of electrically conductive material, a first dielectric substrate, and a second dielectric substrate. A connector is coupled to the antenna element and is adapted to supply electrical energy to the antenna or probe element from an electrical power source. The antenna or probe element is disposed between the first substrate and the second substrate, and the first substrate is bonded to the second substrate to form a substantially planar antenna or probe assembly. The antenna or probe assembly has the form of a motor vehicle mud guard or another substantially planar motor vehicle component.

### RELATED APPLICATION

This application claims the benefit of priority of provisional U.S. application No. 61/111,191 filed Nov. 4, 2008, the disclosure of which is hereby incorporated by reference in its entirety.

### GOVERNMENT LICENSE RIGHTS

The U.S. Government may have a paid-up license in this invention.

### FIELD OF THE INVENTION

The invention relates to radio antennas, and more particularly relates to improved radio antenna systems and covert radio antenna systems for motor vehicles.

### BACKGROUND

As the use of wireless communications, asset tracking, and high-power radio communication systems increases, effective antenna systems for motor vehicles are becoming increasingly important. Currently, motor vehicle antenna systems typically include either clearly visible external antennae or covert antennae that are mounted in various hidden or obscured locations on motor vehicles. Though externally mounted antennae can provide superior reception and transmission over concealed antenna structures, externally mounted antennae can be subject to damage and are not effective for covert applications such as asset tracking or government or military vehicles.

Though known covert antenna systems are advantageous when secrecy is required, the overall performance of known covert antenna systems is less than desired. For example, known covert antenna systems can have resonant characteristics that result in narrow-band operation and require numerous single frequency elements and lower power handling. Such systems can also have higher losses due to higher currents, and can induce high vehicle body currents that produce installation-dependent performance problems. In addition, nearly all existing antennas for wireless communications in vehicles are located in visually apparent external “whips,” plastic housings or glass or plastic transparent window assemblies. Accordingly, there is a need for improved covert antenna systems for motor vehicles that are substantially invisible and cannot be easily tampered with, disabled or removed by unauthorized persons and that overcome the disadvantages associated with known covert antenna systems.

### SUMMARY

One embodiment of the invention includes a covert antenna assembly for a motor vehicle. The antenna assembly can include a substantially planar antenna element comprising a sheet of electrically conductive material, a first dielectric substrate, and a second dielectric substrate. An input connector can be coupled to the antenna element and adapted to supply electrical energy to the antenna element from an electrical power source. The antenna element can be disposed between the first substrate and the second substrate, and the first substrate can be connected to the second substrate to form a substantially planar antenna assembly. The antenna element and/or the first and second substrates can be either substantially flexible or substantially rigid. In one embodiment, the antenna assembly forms a mud guard for a motor vehicle.

In another embodiment the invention includes an antenna system for a motor vehicle of a type having a substantially metal chassis located proximate to the earth's surface. The antenna system can include an antenna probe adapted to be mounted to the motor vehicle at an elevation that is between the vehicle's chassis and the earth's surface. The antenna probe can be adapted to interact with the chassis and the earth's surface and to produce a surface wave pattern that extends outward from the vehicle and substantially parallel to the earth's proximate surface.

Another embodiment of the invention includes an antenna system for a motor vehicle that includes a first antenna or probe adapted to be mounted at a first location on the motor vehicle and one or more additional antennas or probes adapted to be mounted at one or more other locations on the motor vehicle. The first antenna probe and the second antenna probe can be configured to cooperatively generate a desired composite power pattern when power is supplied to the antennas or probes.

These and other aspects and features of the invention will be understood from a reading of the following detailed description together with the drawings.

### BRIEF DESCRIPTION OF THE DRAWINGS

FIG. 1 is an exploded perspective view of a first embodiment of an antenna assembly according to the invention.

FIG. 2 is an exploded perspective view of a second embodiment of an antenna assembly according to the invention.

FIG. 3 is an exploded perspective view of a third embodiment of an antenna assembly according to the invention.

FIG. 4 is an exploded perspective view of a fourth embodiment of an antenna assembly according to the invention.

FIG. 5 is an exploded perspective view of a fifth embodiment of an antenna assembly according to the invention.

FIG. 6 is a rear perspective view of a motor vehicle equipped with an antenna assembly according to the invention.

FIG. 7 is a bottom perspective view of a portion of a motor vehicle equipped with a bottom-mounted antenna probe according to the invention.

FIG. 8 is a side elevation view of a motor vehicle chassis equipped with a bottom mounted antenna and a surface wave pattern generated by the antenna and chassis.

FIG. 9 is a perspective view of an omni-directional wave pattern generated by a bottom-mounted antenna and a motor vehicle chassis.

FIGS. 10a-10d are perspective views of various bottom-mounted antennae probes according to the invention.

FIG. 11A is an exploded view of a front portion of a motor vehicle equipped with a pair of covert antenna assemblies.

FIG. 11B is an exploded view of a rear portion of a motor vehicle equipped with a pair of covert antenna assemblies and a mud guard antenna assembly.

FIG. 12 is a plan view of an omni-directional power pattern produced by a pair of antenna assemblies mounted at different locations on a motor vehicle.

FIG. 13 is a perspective view of an antenna assembly configured to be mounted behind a vehicle headlight assembly.

FIG. 14 is a perspective view of an antenna assembly configured to be mounted behind a vehicle taillight assembly.

### DETAILED DESCRIPTION

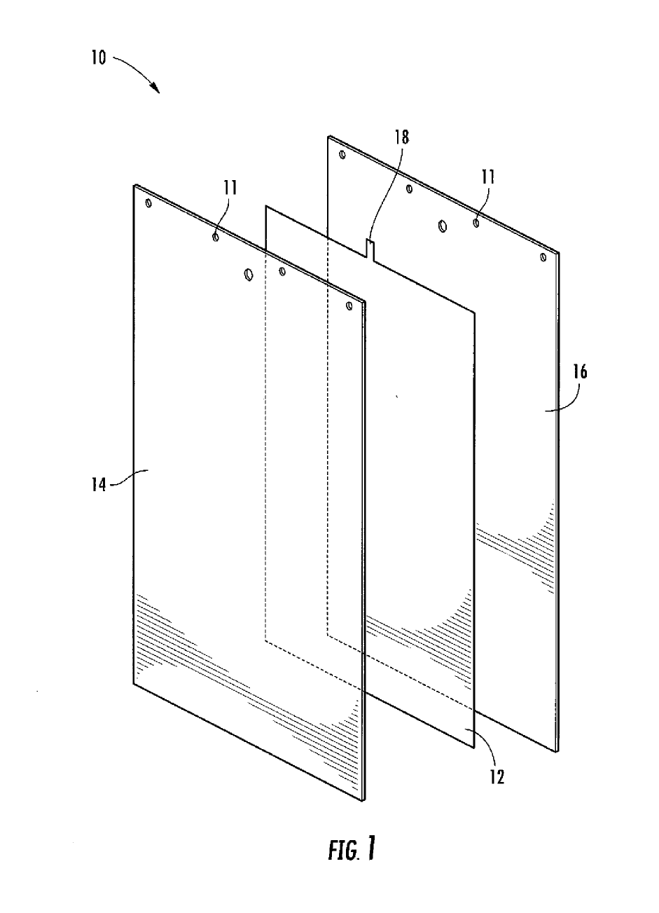

FIG. 1 shows one embodiment of a motor vehicle antenna or radio frequency probe assembly 10 according to the invention. The antenna or probe assembly 10 includes a substantially planar antenna element or antenna probe 12 having a substantially rectangular shape. The antenna element or probe 12 can be constructed of a thin and flexible sheet of electrically conductive material such as a thin sheet of metal foil or a thin metallic film, for example. A connector tab 18 can be provided on the antenna element or probe 12 for use in connecting the antenna element or probe 12 to a cable and a broadcasting and/or receiving device. The thin planar antenna element or probe 12 is sandwiched between a substantially planar first dielectric substrate 14 and a substantially planar second dielectric substrate 16. As shown in FIG. 1, the first and second dielectric substrates 14, 16 can be of the same size and shape, and can each be at least slightly larger than the antenna element or probe 12. The first and second dielectric substrates 14, 16 can be constructed of an electrically non-conductive material such as rubber, another polymeric material, or the like. The first and second dielectric substrates 14, 16 and the antenna element or probe 12 can be bonded together using a suitable adhesive material, a vulcanizing or other bonding process, or another attachment means such as rivets, staples, clips, or the like. The first and second dielectric substrates 14, 16 can include aligned mounting holes 11 for use in mounting the antenna assembly 10 to another structure.

The antenna or probe assembly 10 is substantially planar, and can be used as a mud guard (also known as a “mud flap”) or another substantially planar component of a motor vehicle. When the first and second dielectric substrates 14, 16 are constructed of one or more flexible materials such as rubber or the like, the antenna or probe assembly 10 is also substantially flexible. Alternatively, when one or both of the first and second dielectric substrates 14, 16 are constructed of a substantially rigid dielectric material, the antenna or probe assembly 10 is also substantially rigid. The first and second dielectric substrates 14, 16 insulate and protect the embedded antenna element or probe 12. In particular, the first and second dielectric substrates 14, 16 protect the antenna element or probe 12 from corrosion and damage caused by road debris, rain, snow, ice and other environmental hazards.

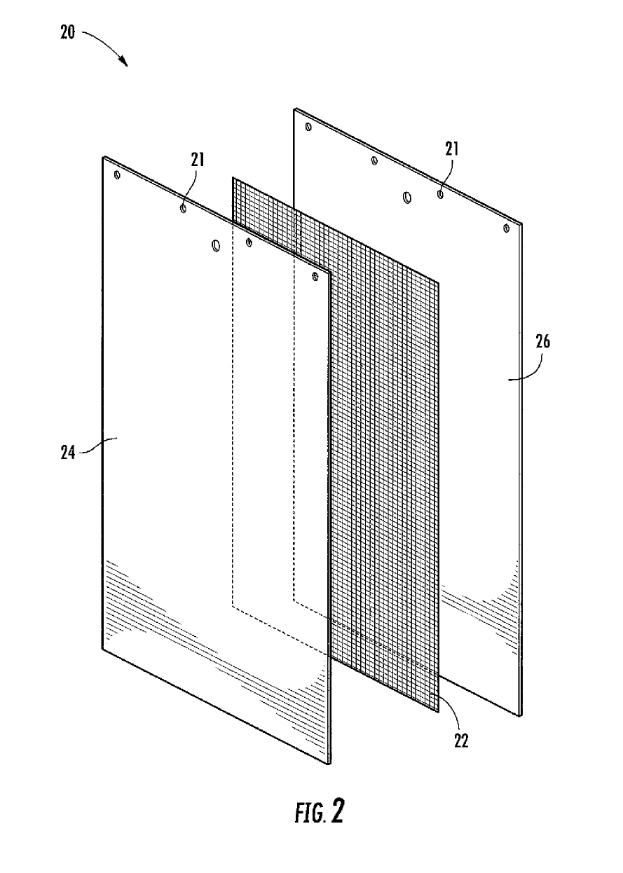

A second embodiment of an antenna or probe assembly 20 is shown in FIG. 2. In this embodiment, the antenna or probe assembly 20 includes a substantially planar wire mesh antenna element or probe 22 having a substantially rectangular shape. The antenna element or probe 22 can be constructed of a woven metal wire screen, an expanded metal mesh, a perforated metal sheet, or the like. The antennae element or probe 22 can be constructed of substantially any electrically conductive material, such as aluminum, copper, bronze or the like. Like the antenna or probe assembly 10 described above, the antenna element or probe 22 is sandwiched between a substantially planar first dielectric substrate 24 and a substantially planar second dielectric substrate 26. The first and second dielectric substrates 24, 26 and the antenna element or probe 22 can be bonded together using a suitable adhesive material. In this embodiment, openings in the metal mesh allow the first and second dielectric substrates 24, 26 to be bonded together through the openings. Alternatively, when the first and second dielectric substrates 24, 26 are bonded together by a vulcanizing or other bonding process, the first and second dielectric substrates 24, 26 may be bonded together through the openings in the antenna element or probe 22. The first and second dielectric substrates 24, 26 can include aligned mounting holes 21 for use in mounting the antenna or probe assembly 20 to another structure. The antenna or probe assembly 20 is substantially planar, and can be used as a mud guard or another substantially planar component of a motor vehicle. When the first and second dielectric substrates 24, 26 are constructed of one or more flexible materials such as rubber or the like, the antenna or probe assembly 20 is also substantially flexible. Alternatively, when one or both of the first and second dielectric substrates 24, 26 are constructed of a substantially rigid dielectric material, the antenna or probe assembly 20 is also substantially rigid. The first and second dielectric substrates 24, 26 insulate and protect the embedded antenna element or probe 22.

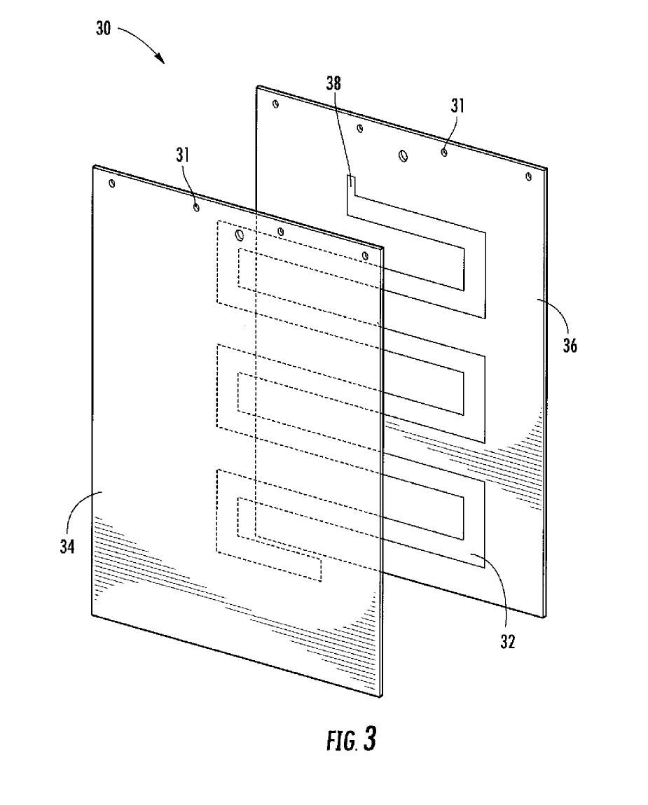

FIGS. 3 and 4 show additional embodiments of antenna or probe assemblies 30, 40. In FIG. 3, a meandering or serpentine antenna element or probe 32 is sandwiched between two dielectric substrates 34, 36. A connector tab 38 of the antenna or probe element 32 can be used to connect the antenna or probe element 32 to a broadcasting and/or receiving device. In FIG. 4, a phased array antenna element or probe 42 having a “corporate fed” shape is sandwiched between two dielectric substrates 44, 46. A connector tab 48 of the antenna element or probe 42 can be provided to connect the antenna element or probe 42 to a broadcasting and/or receiving device. Such phased array and corporate fed antennas and probes are well understood by persons of ordinary skill in the art. Otherwise, the antenna or probe assemblies 30, 34 can be substantially similar to the antenna or probe assemblies 10, 20 described above. As will be apparent to persons of ordinary skill in the art, substantially any shape of planar antenna elements or probes can be incorporated into an antenna or probe assembly like antenna or probe assemblies 10, 20, 30 and 40 described above.

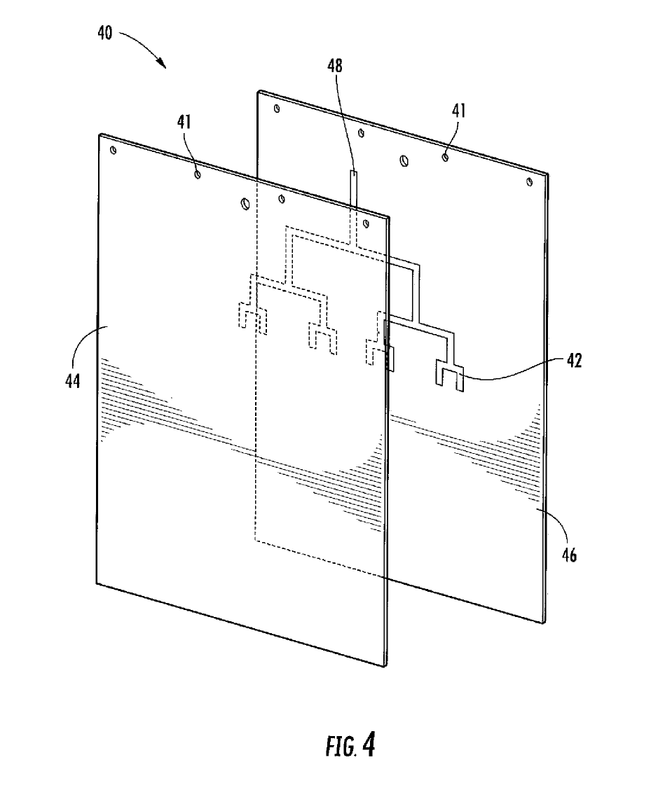

FIG. 5 shows another embodiment of an antenna or probe assembly according to the invention. In this embodiment, two substantially L-shaped antenna elements or probes 52, 57 are arranged in a dipole arrangement and are adhered to or disposed on opposed sides of an intermediate dielectric substrate 53. The antenna elements or probes 52, 57 and intermediate substrate 53 can be sandwiched between two dielectric substrates 54, 56. The intermediate substrate 53 can provide additional support and protection for the antenna elements or probes 52, 57. The intermediate substrate 53 can be constructed of a flexible or rigid dielectric material, for example. The material forming the intermediate substrate 53 can be selected based on dielectric properties, losses, mechanical properties, and cost. For example, the intermediate substrates can be fiberglass/epoxy, phenolics, polymers, rubber, and any other insulating material that can accommodate conductive elements adhered to or formed on the surfaces of the intermediate substrate 53. The substrates 53, 54 and 56 can be bonded together by an adhesive material or a vulcanizing or other bonding process to form a substantially unitary structure. Like the antenna or probe assemblies 10, 20, 30, and 40 described above, the antenna or probe assembly 50 can be used as a mud guard or another substantially planar component of a motor vehicle, such as a body panel, a portion of a bumper cover, a portion of a fender, or the like. FIG. 6 shows two antenna or probe assemblies 10, 20, 30, 40 or 50 installed as mud guards on a motor vehicle 60. Alternatively, the vehicle 60 can include one or more antenna or probe assemblies 10, 20, 30, 40 or 50 mounted on only one side of the vehicle 60, or two or more antenna or probe assemblies 10, 20, 30, 40 or 50 mounted on opposite sides of the vehicle 60.

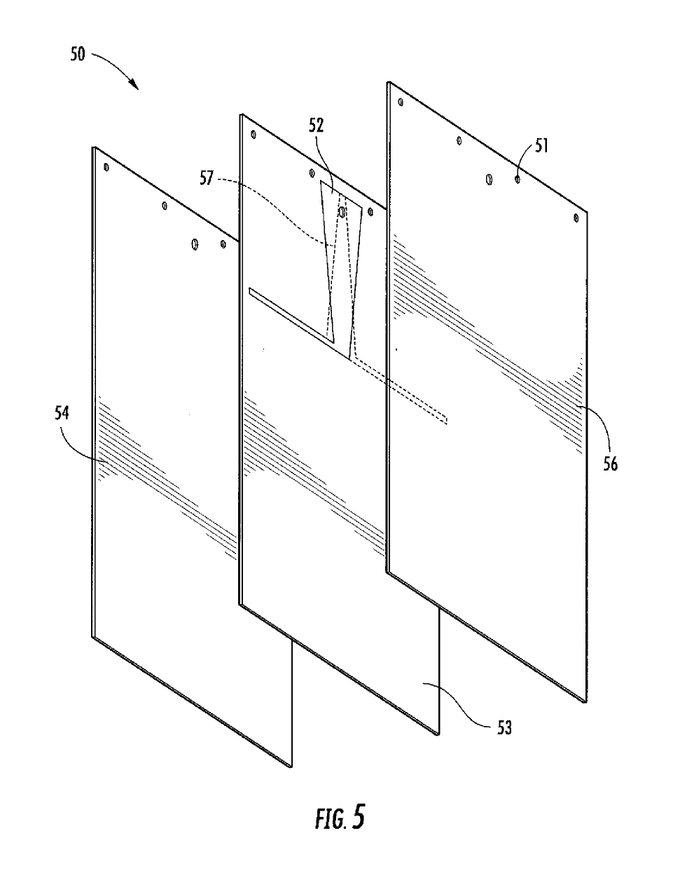

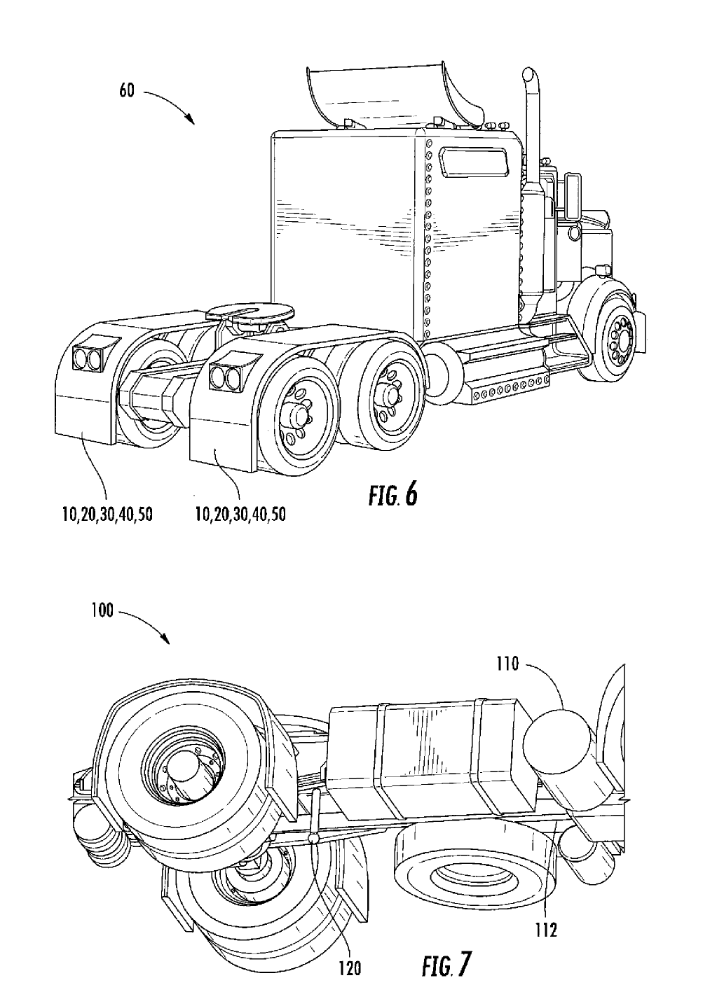

FIG. 7 shows another antenna or probe system 100 according to the invention. In this embodiment, an antenna or probe 120 is mounted beneath a chassis 112 of a motor vehicle 110. The chassis 112 is at least partially constructed of an electrically conductive material, such as steel, for example. The antenna or probe 120 is located below the chassis 112 and above the surface of the earth on which the vehicle 110 sits. In this arrangement, the antenna or probe 120 is configured to excite the vehicle chassis 112 such that outer edges of the chassis 112 act as radiating elements. In this way, the antenna or probe system 100 can function like a proximity-coupled fed microstrip patch planar antenna of a type known in the art. The antenna or probe system 100 is capable of operating in at least two different modes to generate at least two substantially different wave patterns. As shown in FIG. 8, in a first mode of operation, the antenna or probe 120 interacts with the vehicle chassis 112 and the surface of the earth 130 to produce a surface wave pattern 140 that extends outward from the vehicle 110 and substantially parallel to the proximate earth's surface 130. For lower frequencies (such as frequencies less than about 150 MHz, for example) a surface wave pattern 140 like that shown in FIG. 8 typically provides a higher gain and lower loss over larger distances than radiation patterns launched in free space. As shown in FIG. 9, in a second parallel wave guide mode, the antenna or probe 120 interacts with the vehicle chassis 112 and the proximate surface of the earth 130 to produce a hemispherical wave pattern 150 that surrounds the vehicle 110. Such a hemispherical wave pattern 150 may be more desirable for receiving and broadcasting signals at higher frequencies, such as frequencies at or above about 150 MHz, for example. Other wave patterns can also be produced by the antenna or probe system 100. The two distinct wave patterns 140, 150 described above can be achieved by altering the configuration of the antenna or probe 120 and/or by adjusting the location of the antenna or probe 120 relative to the chassis 112 and/or proximate earth surface 130. In addition or alternatively, the electrical size of the radiating portion of the antenna or probe 120 can be electronically tuned to selectively modify the coupling effect between a vehicle's chassis 112 and the earth's surface 130. Accordingly, the antenna or probe system 100 can be tuned to adapt to different vehicles having different chassis sizes, chassis configurations and/or chassis elevations by reconfiguring, tuning and/or repositioning the antenna or probe 120.

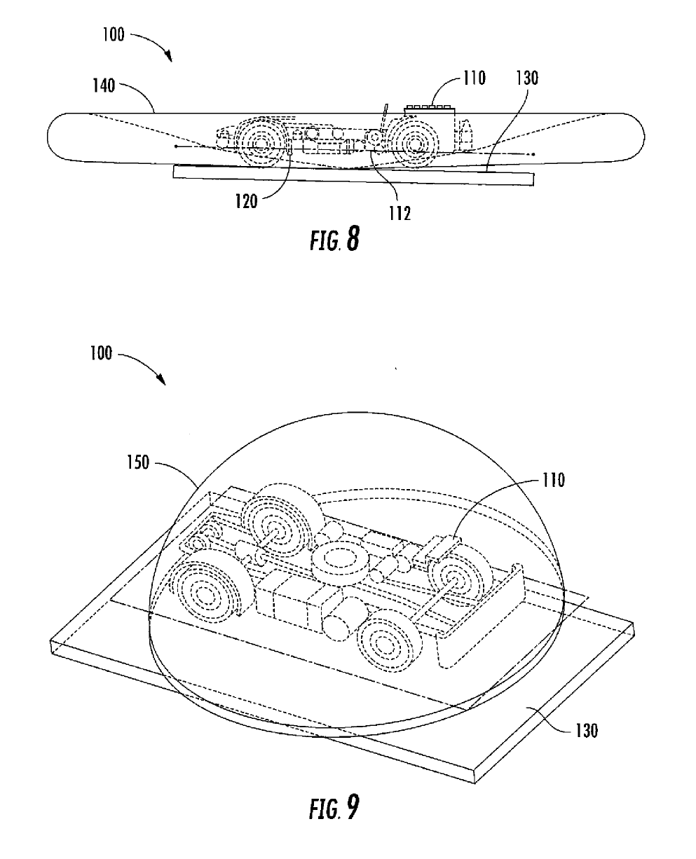

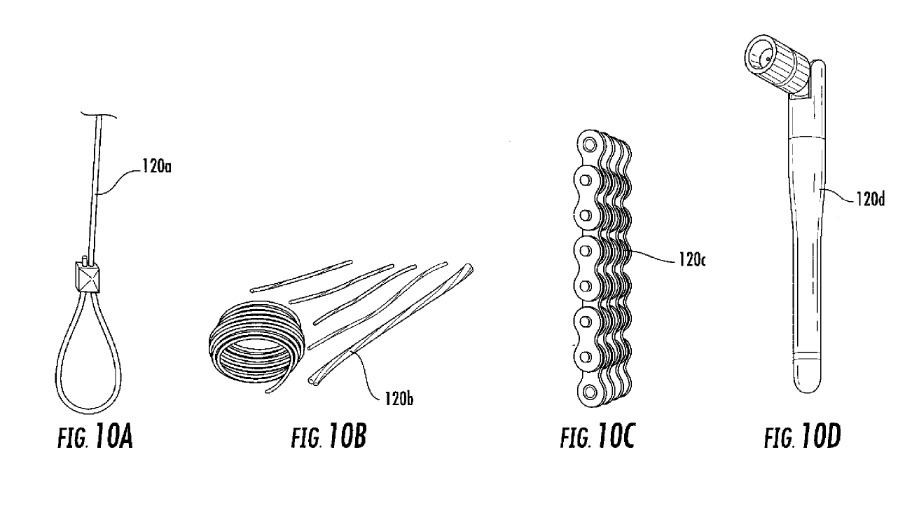

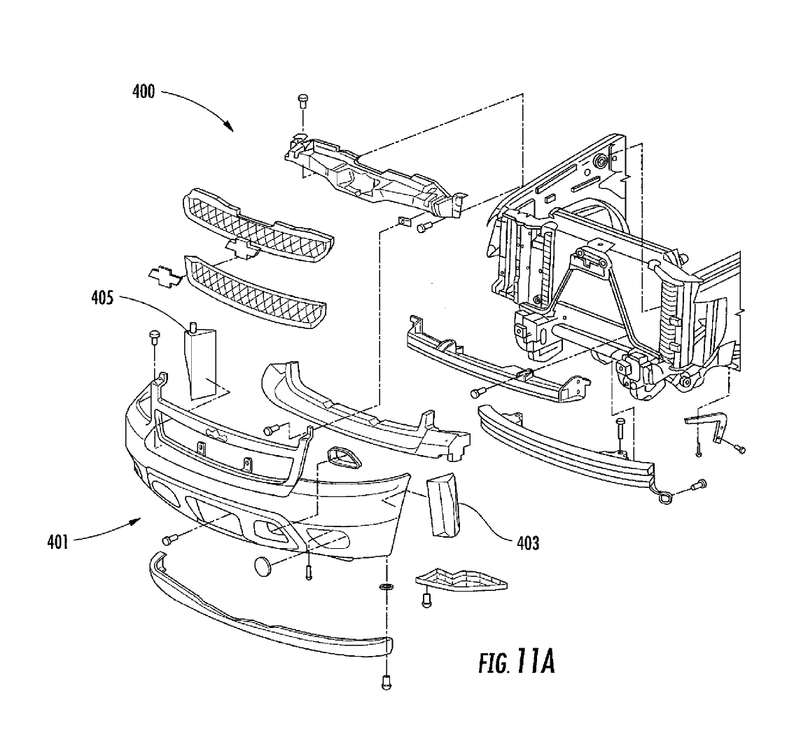

The antenna or probe 120 can have a variety of forms and arrangements. FIGS. 10a-10d show a variety of antennas or probes 120a-120d that can be configured to interact with a vehicle's chassis 112 to generate radiation wave patterns like the radiation wave patterns 140 and 150 described above. In FIG. 10a, the antenna or probe 120a is a length of wire rope with a loop on one end. In FIG. 10b, the antenna or probe 120b is a straight length of metal wire, wire rope or coaxial cable. In FIG. 10c, the antenna or probe 120c is a length of chain with a series of interconnected links. In FIG. 10d, the antenna or probe 120d can include a dipole or monopole antenna or probe element housed within an elongated tube or housing. Each of the antennas or probes 120a-120d can be vertically suspended beneath a vehicle, for example. When feasible, the antenna or probe 120 can be mounted such that antenna probe 120 drags along the ground in order to enhance a ground wave propagation mode. The antenna or probe 120 can also be located beneath a vehicle at a location that provides a desired power pattern for a particular frequency and/or application. The inconspicuous antennas or probes 120a-120c shown in FIGS. 10a-10d can be used when the antenna or probe system 100 is a covert or secret antenna or probe system, such as when the system is used to track the location of a motor vehicle 110 without the knowledge of the vehicle's driver or others, for example. In addition, a mud guard antenna or probe assembly like one of the antenna or probe assemblies 10, 20, 30, 40, and 50 described above can be mounted under the chassis 112 and can be configured to excite a vehicle's chassis 112 to produce different wave patterns 140, 150 like those described above.

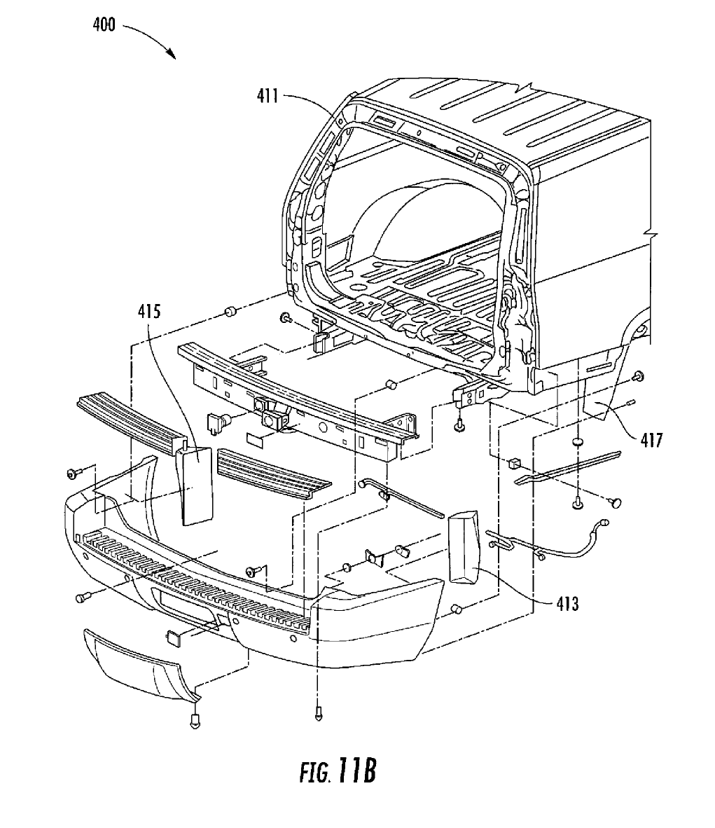

FIGS. 11A-14 show a multi-band high-power distributed antenna or probe system 400 according to the invention. As shown in FIGS. 11A and 11B, a plurality of antenna or probe assemblies 403, 405, 413, 415 and 417 can be positioned at various locations on either a front portion 401 or a rear portion 411 of a motor vehicle, for example. As shown in FIG. 11A, a first antenna or probe assembly 403 can be positioned at a left front location of the front vehicle portion 401, and a second antenna or probe assembly 405 can be positioned at a right front location of the front vehicle portion 401. As shown in FIG. 11B, a third antenna or probe assembly 413 can be positioned at a right rear location of the rear vehicle portion 411, and a fourth antenna or probe assembly 415 can be positioned at a left rear location of the rear vehicle portion 411. Thus, the first antenna or probe assembly 403 and the third antenna or probe assembly 413 can be positioned at opposed corners of the vehicle, and the second antenna or probe assembly 405 and the fourth antenna or probe assembly 415 can also be positioned at opposed corners of the vehicle. In addition, the first antenna or probe assembly 403 and the third antenna or probe assembly 413 can both be configured and tuned to operate at a first range of frequencies, and the second antenna or probe assembly 405 and the fourth antenna or probe assembly 415 can both be configured and tuned to operate at a second range of frequencies that is different from the first range of frequencies. As shown in FIG. 11B, a fifth antenna or probe assembly 417 can be positioned beneath the rear portion 411 of the vehicle. The fifth antenna or probe assembly 417 can be like one of the mud guard antenna or probe assemblies 10, 20, 30, 40 or 50 described above, and can be configured and tuned to operate at a third frequency that is different from the first and second frequencies, for example.

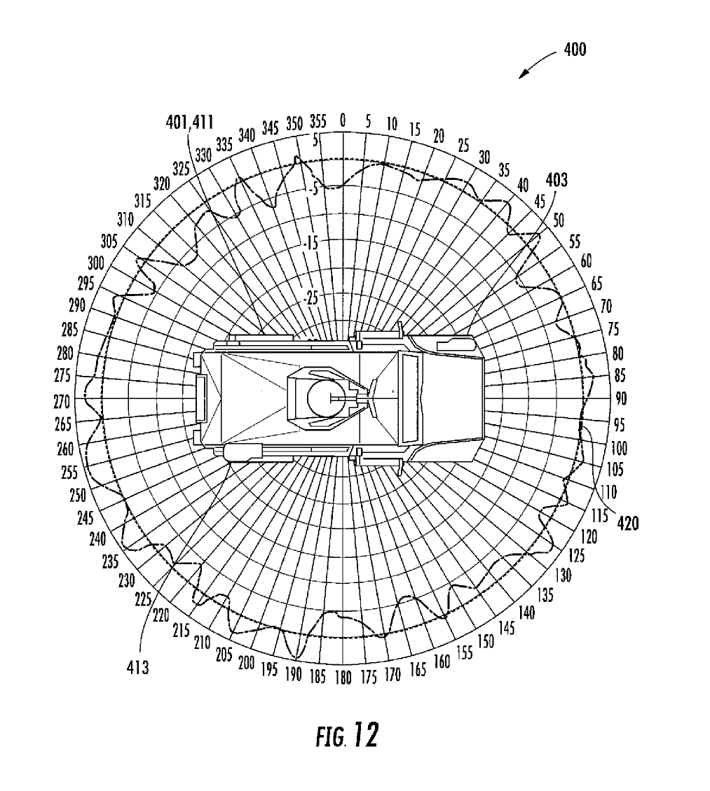

As shown in FIG. 12, the locations of first antenna or probe assembly 403 and the third antenna or probe assembly 413 allow the two antenna or probe assemblies 403, 413 to cooperate to produce a composite wave pattern 420 around the vehicle 401, 411 for receiving and/or transmitting radio signals at the first frequency. The wave pattern 420 can be either omni-directional as shown in FIG. 12, or can be a directional wave pattern, for example. Similarly, the spaced-apart second antenna or probe assembly 405 shown in FIG. 11A and the fourth antenna or probe assembly 415 shown in FIG. 11B can cooperate to produce a composite wave pattern for receiving and/or transmitting radio signals at the second frequency. Signals can be broadcast and/or received at the third frequency using the fifth antenna or probe assembly 417 shown in FIG. 11B, for example. One or more control devices can be provided for adjusting a wave pattern generated by one or more of the antenna or probe assemblies 403, 405, 413, 415 and 417. For example, a control device may be used to adjust a wave pattern produced by one or more of the antenna or probe assemblies 403, 405, 413, 415 and 417 to yield a composite wave pattern that is either directional or omni-directional, for example. Suitable phasing control devices for adjusting the wave patterns generated by one or more of the antenna or probe assemblies 403, 405, 413, 415 and 417 are known to persons of ordinary skill in the art.

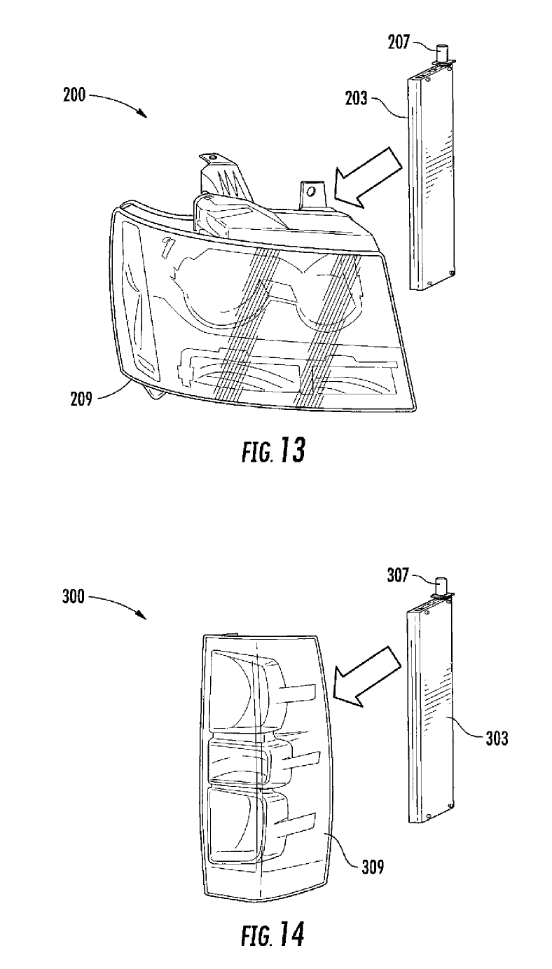

As shown in FIG. 13, an antenna or probe system 200 similar to the antenna or probe system 400 described above can include a substantially flat antenna or probe assembly 203 which can be installed and hidden from view behind a headlight assembly 209. Similarly, as shown in FIG. 14, an antenna or probe system 300 like the antenna or probe system 400 described above can include a substantially flat antenna or probe assembly 303 which can be installed and hidden from view behind a tail light assembly 309. The hidden antenna or probe assemblies 203, 303 can include connectors 207, 307 for connecting the antenna or probe assemblies 203, 303 to an onboard broadcasting and/or receiving device.

The antenna or probe systems described above can be used with substantially any type of motor vehicle, and can be installed such that they are invisible to persons who do not know of their existence. For example, the antenna or probe systems described above are particularly well suited for use in tracking commercial fleet trucks and trailers, rental trucks and trailers, delivery vehicles and the like. The clandestine nature of these antenna or probe systems provide a substantially undetectable means for broadcasting information such as a vehicle's whereabouts or speed and the current status of a vehicle's onboard equipment, for example. The antenna or probe systems can also be used to relay information generated by on onboard global positioning device, for example, for use by owners, schedulers, authorities or other concerned parties.

The above-described antenna or probe systems can be configured to accommodate a wide variety of radio frequencies, and can be adapted for substantially any application, including satellite communications, terrestrial communications, vehicle-to-vehicle communications, jamming, aircraft, and other common communications applications, for example.

The above descriptions of various embodiments of the invention are intended to explain and highlight certain aspects and features of the invention, and are not intended to limit the invention to the specific embodiments described herein. Persons of ordinary skill in the art will understand that various changes and modifications can be made to the specifically described embodiments without departing from the scope of the invention. All such changes and modifications are intended to be within the scope of the appended claims.

What is claimed is:

1. An antenna or radio frequency probe assembly for a motor vehicle comprising:
a. a substantially flexible or rigid planar antenna element or probe comprising a sheet of electrically conductive material;
b. a first insulating substrate;
c. a second insulating substrate; and
d. an input connector coupled to the antenna element or probe and adapted to supply electrical energy to the antenna element or probe from an electrical power source;
e. wherein the antenna element or probe is disposed between the first substrate and the second substrate and the first substrate is connected to the second substrate to form a substantially flexible or rigid planar antenna or probe assembly.

2. The antenna or radio frequency probe assembly of claim 1 wherein the thin sheet of electrically conductive material comprises a wire mesh having a plurality of openings therein, and wherein the first substrate is connected to the second substrate through at least some of the openings.

3. The antenna or radio frequency probe assembly of claim 1 wherein the thin sheet of electrically conductive material comprises a metallic foil, sheet or film.

4. The antenna or radio frequency probe assembly of claim 1 wherein the thin sheet of electrically conductive material has a polygonal, meandering, serpentine, fractal, dipole or corporate-fed shape or pattern.

5. The antenna or radio frequency probe assembly of claim 1 wherein the antenna assembly forms a substantially planar mud guard adapted to be mounted beneath a motor vehicle.

6. The antenna or radio frequency probe assembly of claim 1 wherein the first insulating substrate and the second insulating substrate comprise a polymeric material.

7. The antenna or radio frequency probe assembly of claim 5 wherein the polymeric material is resiliently flexible.

8. The antenna or radio frequency probe assembly of claim 1 wherein the antenna assembly forms at least a portion of a body panel, bumper, or fender of the motor vehicle.

9. An antenna or radio frequency probe system for a motor vehicle of the type having a substantially metal chassis located proximate to a ground surface, the antenna system comprising:
a. an antenna or probe adapted to be mounted to the motor vehicle at an elevation that is between the metal chassis and the ground surface;
b. wherein the antenna or probe is adapted to interact with the metal chassis and the earth ground to produce a surface wave pattern that extends outward from the vehicle and substantially parallel to the earth ground surface.

10. The antenna or radio frequency probe system of claim 9 wherein the antenna or probe is a proximity-coupled coaxial probe configured to downwardly extend from the metal chassis.

11. The antenna or radio frequency probe system of claim 9 wherein the antenna or probe is substantially planar and is embedded in a substantially planar structure having the appearance of a vehicle mud guard.

12. The antenna or radio frequency probe system of claim 9 wherein the antenna or probe is selected from the group consisting of a dipole, a chain, a coaxial cable, a metal cable, a loop, a slot antenna and a monopole.

13. The antenna or radio frequency probe system of claim 9 further comprising a tuner adapted to selectively modify a characteristic of the antenna probe in order to achieve a desired interaction between the antenna or probe and the metal chassis of the motor vehicle such that the surface wave pattern is optimized.

14. An antenna or radio frequency probe system for a motor vehicle comprising:
a. a first antenna or probe adapted to be mounted at a first location on the motor vehicle; and
b. a second antenna or probe adapted to be mounted at a second location on the motor vehicle;
c. wherein the first antenna or probe and the second antenna or probe are configured to cooperatively generate a desired composite power pattern when power is supplied to the first and second antennas or probes.

15. The antenna or radio frequency probe system of claim 14 wherein the composite power pattern is substantially omni-directional around the motor vehicle.

16. The antenna or radio frequency probe system of claim 14 wherein the composite power pattern is substantially directional.

17. The antenna or radio frequency probe system of claim 14 further comprising one more additional antennas or probes adapted to be mounted at one or more other locations on the motor vehicle, wherein the first antenna or probe, the second antenna or probe and the one more additional antennas or probes are configured to cooperatively generate a composite power pattern when power is supplied to the first and second antennas or probes and the one or more additional antennas or probes.

18. The antenna or radio frequency probe system of claim 14 further comprising a control device for selectively altering an individual power pattern produced by the first and second antenna probes.

19. The antenna or radio frequency probe system of claim 16 further comprising a control device for selectively altering an individual power pattern produced by the first and second antenna probes.

20. The antenna or radio frequency probe system of claim 14 wherein the motor vehicle includes a vehicle component, and wherein at least one of the antenna probes is disposed within the vehicle component.

21. The antenna or radio frequency probe system of claim 18 wherein the vehicle component is selected from the group consisting of a body panel, a bumper, a fender, a headlight, a tail light and a mud guard.
